(19) United States
(12) Patent Application Publication
(10) Pub. No.: US 2023/0173733 A1
(43) Pub. Date: Jun. 8, 2023

(54) METAL MEMBER, AND METHOD FOR PROCESSING RUBBER MATERIAL USING DEVICE COMPRISING SAID METAL MEMBER

(71) Applicant: KABUSHIKI KAISHA KOBE SEIKO SHO (KOBE STEEL, LTD.), Hyogo (JP)

(72) Inventors: Hodaka MIURA, Takasago-shi, Hyogo (JP); Wendong XU, Takasago-shi, Hyogo (JP)

(73) Assignee: KABUSHIKI KAISHA KOBE SEIKO SHO (KOBE STEEL, LTD.), Hyogo (JP)

(21) Appl. No.: 17/999,837

(22) PCT Filed: Jun. 2, 2021
(86) PCT No.: PCT/JP2021/021063

§ 371 Date: Nov. 23, 2022

(30) Foreign Application Priority Data
Jul. 22, 2020 (JP) 2020-125671
Dec. 10, 2020 (JP) 2020-204866

(51) Int. Cl. B29C 48/515; B29C 48/00; B29C 48/505

(52) U.S. Cl. CPC B29C 48/515; B29C 48/022; B29C 48/507

(57) ABSTRACT

A metal member according to the present invention is a metal member having a surface in contact with a rubber material, wherein at least a portion of the surface of the metal member in contact with the rubber material is formed from an alloy containing cobalt and chromium, and the metal member comprises a fluid passage for adjusting a temperature of the at least a portion of the surface of the metal member in contact with the rubber material.

### TECHNICAL FIELD

The present invention relates to a metal member and a method for processing a rubber material using a device comprising the metal member.

### BACKGROUND ART

Generally, various metal members are provided in a processing device that performs kneading of a rubber material, extrusion or rolling of the rubber material after kneading, and the like. Examples of such a member include a screw for extruding a rubber material, a barrel (or also referred to as a cylinder) which is a housing in which the screw is accommodated, a calendar roll (or simply referred to as a roll) for rolling the rubber material into a sheet shape, and a side guide provided at an end of the calendar roll. Usually, chrome plating or the like for preventing adhesion of the rubber material is applied to surfaces of these members.

In addition, as a technique for preventing the rubber material from adhering to the surface of the member provided in the processing device, for example, there is a technique for forming a surface or the like in contact with the rubber material into a characteristic structure. For example, Patent Literature 1 discloses a rubber processing device having a metal surface in contact with rubber, in which surface roughness of the metal surface is in a range of Ra = 5 to 50 µm. Patent Literature 2 discloses a member in contact with a rubber material, wherein the member has a surface in contact with the rubber material, and a contact angle of the surface in contact with the rubber material is 40° or more when a liquid rubber to be tested, which can maintain a liquid state at normal temperature by being synthesized by reducing a molecular weight of a rubber composition used for the rubber material, is placed on the surface.

### CITATION LIST

### Patent Literature

Patent Literature 1: JP 2004-209939 A
Patent Literature 2: JP 5,892,894 B2

### SUMMARY OF THE INVENTION

An object of the present invention is to provide a metal member in which a rubber material is less likely to adhere to various types of rubber materials in a wide temperature range.

As a result of intensive studies to solve the above problems, the present inventors have reached the present invention.

That is, a metal member according to one aspect of the present invention is a metal member having a surface in contact with a rubber material, wherein
at least a portion of the surface of the metal member in contact with the rubber material is formed from an alloy containing cobalt and chromium, and
the metal member comprises a fluid passage for adjusting a temperature of the at least a portion of the surface of the metal member in contact with the rubber material.

### BRIEF DESCRIPTION OF THE DRAWINGS

FIG. 1 is a view schematically illustrating an example of a configuration of a rubber material processing device comprising a metal member according to an embodiment of the present invention;

FIG. 2 is a view illustrating a schematic cross section of a calendar roll which is an example of the metal member according to the embodiment of the present invention; and

FIG. 3 is a view illustrating a schematic cross section of a calendar roll which is another example of the metal member according to the embodiment of the present invention.

### DESCRIPTION OF EMBODIMENTS

The technique described in Patent Literature 1 or Patent Literature 2 as described above is a technique for preventing a rubber material from adhering to a member of a processing device by giving a characteristic to a surface structure of the member in contact with the rubber material.

However, it has been found that if a surface constituent element of the metal member, the type of the rubber material, and a metal member surface temperature adjusted by a fluid passage provided in the metal member are not suitably selected and combined, adhesion of the rubber material cannot be prevented at the time of processing in some cases. That is, if not the metal member of the device is changed in accordance with the type of the rubber material and the metal member surface temperature is adjusted to a suitable temperature in accordance with the type of the rubber material, the rubber material adheres to the metal member frequently, which may eventually lead to a decrease in production of a rubber product. Thus, there is a demand for a metal member capable of reducing restriction during operation of such a rubber material processing device.

Therefore, the present inventors have conducted various studies on a metal member to which a rubber material is less likely to adhere in a wide temperature range regardless of the type of the rubber material, and they have focused on constituent elements on the surface of the metal member to complete the present invention.

Hereinafter, an embodiment of the present invention will be described in detail. The scope of the present invention is not limited to the embodiment described herein, and various modifications can be made without impairing the gist of the present invention.

### Metal Member

The metal member according to the present embodiment is a metal member having a surface in contact with a rubber material, in which at least a portion of the surface of the metal member in contact with the rubber material is formed from an alloy containing cobalt and chromium. Furthermore, the metal member comprises a fluid passage for adjusting a temperature of the at least a portion of the surface in contact with the rubber material.

In the metal member according to the present embodiment, the rubber material is less likely to adhere to various types of rubber materials in a wide temperature range.

That is, adhesion to various types of rubber materials can be prevented by forming the surface of the metal member in contact with the rubber material (hereinafter, also referred to as “surface portion of the metal member in contact with the rubber material”) into an alloy containing cobalt which hardly causes oxidation or corrosion and chromium which is a hard metal excellent in scratch resistance and abrasion resistance effect. In addition, by forming the surface of the metal member in such an alloy configuration, even when the surface temperature of the metal member is adjusted to various temperatures using the fluid passage, the surface portion of the metal member has an effect of preventing adhesion to the rubber material in a wide temperature range.

The “metal member” in the present specification is a member having a surface in contact with the rubber material, and specifically, may be a member provided in a device that performs processing such as kneading, extrusion, and/or rolling of the rubber material. For example, the metal member is preferably any member selected from a screw that extrudes the rubber material, a barrel that is a housing of the screw and forms a flow path of the rubber material, a calendar roll of a roller head that rolls the rubber material, and a side guide provided at an end of the calendar roll. Among these members, the metal member is more preferably the calendar roll of the roller head from the viewpoint that the calendar roll is provided most downstream in a processing process in a device that processes the rubber material and adhesion of the rubber material easily occurs.

The “rubber material” in the present specification means a material that contains a rubber component such as styrene-butadiene rubber (SBR), butadiene rubber (BR), natural rubber (NR), or chloroprene rubber as a main component, and is subjected to processing such as kneading, extrusion, and/or rolling using a device comprising the metal member according to the present embodiment. The rubber material may contain, as auxiliary components, a filler, an oil, a resin component, a pressure-sensitive adhesive, a vulcanizing agent, a vulcanization accelerator, an antiaging agent, an antioxidant, and the like in addition to the rubber component as the main component.

When the rubber material further comprises silica and a silane coupling agent, the metal member according to the present embodiment can more effectively exhibit the effect of preventing adhesion of the rubber material. Silica is added to the rubber material to reinforce a chemical structure of rubber during vulcanization. The silane coupling agent is added to the rubber material to further enhance the reinforcing effect by silica. Examples of the silane coupling agent include (bis(triethoxysilylpropyl)polysulfide) such as TESPT and TESPD, trimethoxysilylpropanethiol, and 3-octanoylthio-1-propyltriethoxysilane.

When the rubber material comprises silica and a silane coupling agent, in the extrusion and/or rolling step, a film is formed on the surface of the metal member by an unreacted silane coupling agent that is not bonded to silica during kneading, and as a result, the rubber material is more likely to adhere to the metal member. Specifically, since silica is harder than other additives of the rubber material such as carbon black, defects such as scratches and abrasion are likely to occur on the surface of the metal member when the surface of the metal member comes into contact with the rubber material comprising silica. Then, since the surface of the metal member has scratches, abrasion, and the like, the unreacted silane coupling agent is likely to be bonded and/or accumulated on the surface, so that the rubber material is more likely to adhere to the metal member. According to the metal member according to the present embodiment, since the surface thereof is excellent in scratch resistance and abrasion resistance effect, it is possible to prevent the formation of a film of the silane coupling agent on the surface of the metal member, and it is possible to effectively prevent adhesion of the rubber material to the surface of the metal member.

In addition, even when an acid is used in the production of the rubber material or a raw material thereof, the metal member according to the present embodiment can more effectively exhibit the effect of preventing adhesion of the rubber material. In particular, when the rubber material comprises silica, an acid, particularly sulfuric acid, is often used in the production of silica. In such a case, in a step such as extrusion and/or rolling of the rubber material, the remaining acid reacts with the surface of the metal member to oxidize the surface of the metal member. Similarly to scratches and abrasion, when the surface of the metal member is oxidized, a film is easily formed on the surface of the metal member by the unreacted silane coupling agent added together with silica, so that the rubber material is more likely to adhere to the metal member. According to the metal member according to the present embodiment, since the surface thereof is hardly oxidized, it is possible to prevent the formation of the film of the silane coupling agent on the metal member surface, and it is possible to effectively prevent adhesion of the rubber material to the metal member surface.

The device comprising the metal member according to the present embodiment, that is, the rubber material processing device is not particularly limited, and examples thereof include a device that kneads a raw material mainly composed of a raw material rubber used for tires and the like, and a screw extruder, a conical twin screw extruder, a roller head screw extruder, a calendar roll, and an open roll, which extrude and/or roll the rubber material after kneading.

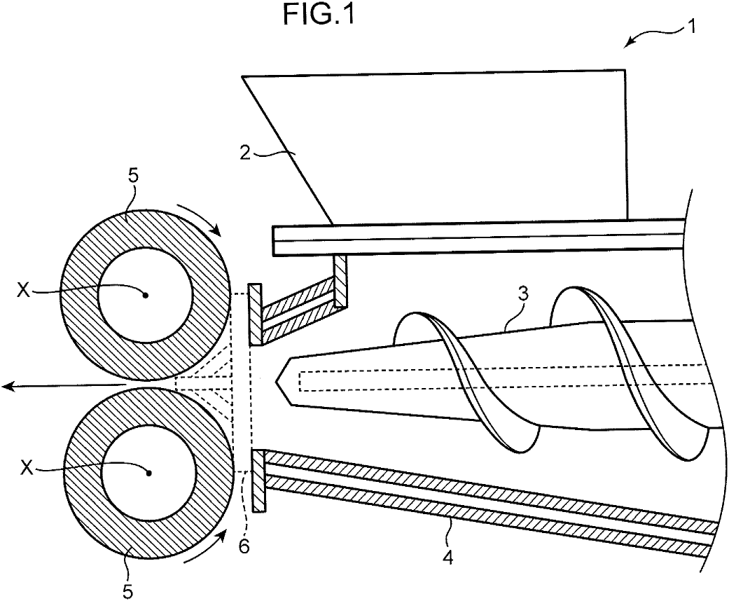

For example, FIG. 1 schematically illustrates an example of a configuration of the rubber material processing device comprising the metal member according to the present embodiment. In FIG. 1, reference numeral 1 represents a rubber material processing device, reference numeral 2 represents a hopper, reference numeral 3 represents a screw, reference numeral 4 represents a barrel, reference numeral 5 represents a calendar roll, reference numeral 6 represents a side guide, and reference numeral X represents a rotation axis. The rubber material processing device 1 comprises the hopper 2, the screw 3, the barrel 4, a pair of the calendar rolls 5, and a pair of the side guides 6. The rubber material after kneading is put into the hopper 2. The screw 3 is rotationally driven to push out the kneaded rubber material. The barrel 4 is a housing that accommodates the screw 3 and forms a flow path of the rubber material. The pair of calendar rolls 5 are rotationally driven to encompass the extruded rubber material, and thus roll the rubber material into a sheet shape. The pair of side guides 6 are provided at both ends along a direction of the rotation axis X of the calendar roll 5, and control a width of the extruded rubber material. Each of these metal members has a surface in contact with the rubber material, and can comprise a fluid passage for adjusting the metal member to a suitable temperature inside or in the vicinity of the surface, or the like.

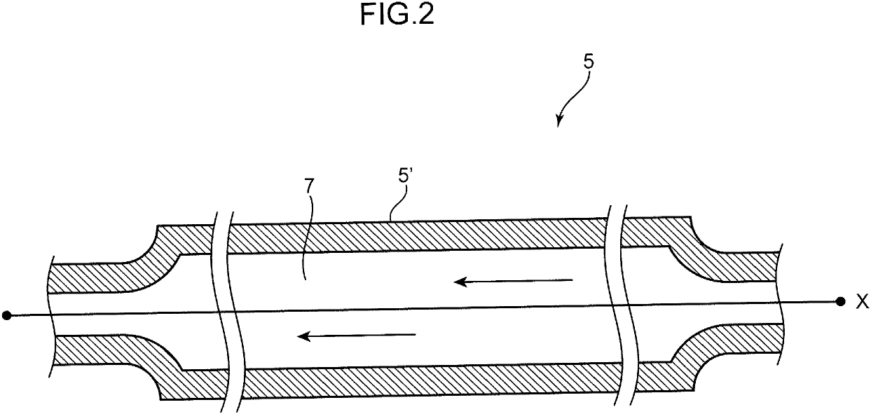

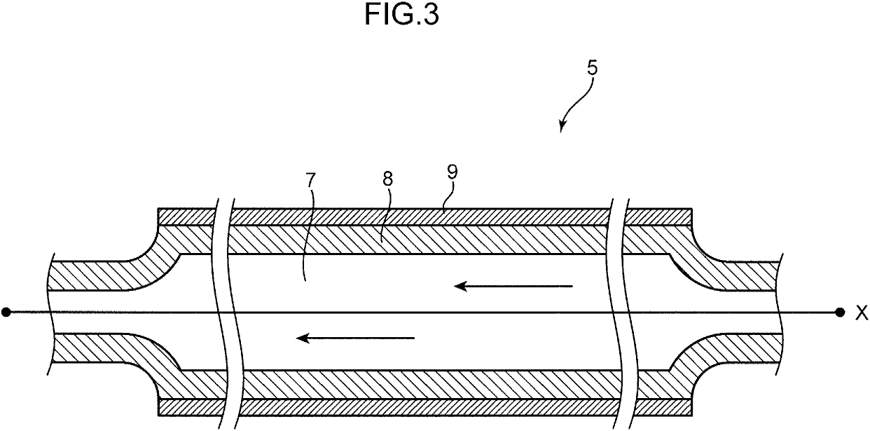

The metal member according to the present embodiment will be described more specifically with reference to FIGS. 2 and 3. FIG. 2 illustrates a schematic cross section of the calendar roll which is an example of the metal member according to the present embodiment. In FIG. 2, reference numeral 5 represents the calendar roll, reference numeral 5′ represents a calendar roll surface portion (surface portion of the metal member in contact with the rubber material), reference numeral 7 represents a fluid passage, and reference numeral X represents the rotation axis. The sectional view of FIG. 2 is a sectional view along the rotation axis X direction of the calendar roll 5. As shown in FIG. 2, the calendar roll 5 (metal member) has the calendar roll surface portion 5′ in contact with the rubber material (surface portion of the metal member in contact with the rubber material) and comprises the fluid passage 7 therein.

The fluid passage 7 is a passage for allowing a fluid such as water adjusted to a specific temperature to pass therethrough. A temperature of the calendar roll surface portion 5′ (surface portion of the metal member in contact with the rubber material) is adjusted to a predetermined temperature range by using the fluid passage 7.

In the present specification, the “predetermined temperature range” may be a temperature range in which the surface temperature of the metal member to be used is determined to be appropriate, i.e., not too high and/or not too low, depending on the type of rubber material, the type and size of the metal member, and the like. Such a temperature range is preferably 20° C. or higher and 90° C. or lower. The temperature range is more preferably 30° C. or higher, and still more preferably 40° C. or higher. The temperature range is more preferably 80° C. or lower, and still more preferably 60° C. or lower. When the temperature of the surface of the metal member in contact with the rubber material is 20° C. or higher, corrosion and the like of the metal member surface can be prevented. When the temperature of the surface of the metal member in contact with the rubber material is 90° C. or lower, generation of rubber scorch can be prevented in processing the rubber material.

A temperature of the fluid passing through the fluid passage 7 may be the same as the predetermined temperature of the surface of the metal member, or may be set to a temperature considering heat exchange between the fluid and the metal member. In any case, a temperature sensor may be provided in the vicinity of the surface of the metal member in contact with the rubber material to control the temperature of the fluid so that a temperature within a predetermined temperature range is always maintained.

Although the fluid passage 7 is located so as to penetrate a center portion along the rotation axis X of the calendar roll 5 in FIG. 2, a specific position of the fluid passage 7 is not limited as long as the fluid passage 7 is provided at a position where the temperature of the surface of the metal member in contact with the rubber material can be adjusted. For example, depending on the type and size of the metal member, the type of the rubber material, the set temperature, and the like, the fluid passages 7 having various shapes may be provided at one or a plurality of locations inside of the metal member and/or on the metal member surface, and the like. For example, in the calendar roll, the fluid passage 7 may be formed in a spiral shape about a roller axis of the calendar roll (see, for example, Japanese Unexamined Patent Application Publication No. H8-39594). For example, when the metal member is a screw, the fluid passage 7 may be provided in an internal space extending to the vicinity of a tip of the screw along a rotation axis of the screw. Alternatively, for example, when the metal member is a barrel, the fluid passage 7 may be provided along a surface of the housing. Alternatively, for example, when the metal member is a side guide, the fluid passage 7 may be provided so that cooled water or the like flows into a gap existing inside the metal member (see, for example, Japanese Unexamined Patent Application Publication No. H8-309826).

The calendar roll surface portion 5′ (surface portion of the metal member in contact with the rubber material) is formed from an alloy containing cobalt and chromium. Specifically, inclusion of cobalt, which hardly causes oxidation or corrosion, in the configuration of the alloy in the surface portion can make it difficult to cause a coupling reaction of a silane coupling agent, which is more likely to bond to the metal surface oxidized, particularly when the rubber material contains the silane coupling agent. In addition, by combining chromium, which is a hard metal, with the alloy, hardness of the alloy forming the calendar roll surface portion 5′ (surface portion of the metal member in contact with the rubber material) can be improved, and scratches and abrasion of the surface portion of the metal member, which are one of the causes of adhesion of the rubber material, can be prevented. A mass ratio in the configuration of the alloy forming the calendar roll surface portion 5′ (surface portion of the metal member in contact with the rubber material) is not particularly limited, and a mass ratio by which the content of cobalt is larger than the content of chromium is preferred. This is because, when attention is paid to suppression of adhesion of the rubber material, inclusion of larger amount of cobalt with respect to chromium makes it more difficult for the silane coupling agent to bond, particularly when the rubber material comprises the silane coupling agent. For example, the calendar roll surface portion 5′ (surface portion of the metal member in contact with the rubber material) may be an alloy containing cobalt in an amount of 60% by mass or more and 80% by mass or less and chromium in an amount of 20% by mass or more and 40% by mass or less.

In addition, the alloy containing cobalt and chromium of the calendar roll surface portion 5′ (surface portion of the metal member in contact with the rubber material) preferably further contains one or more elements selected from tungsten, molybdenum, boron and carbon. When these elements are contained, the calendar roll surface portion 5′ (surface portion of the metal member in contact with the rubber material) is preferably an alloy containing cobalt in an amount of 39% by mass or more and 71% by mass or less, chromium in an amount of 8% by mass or more and 35% by mass or less, and one or more elements selected from tungsten, molybdenum, boron, and carbon in an amount of 0.1% by mass or more and 30% by mass or less. By adding an element selected from tungsten, molybdenum, boron, and carbon, the hardness of the alloy can be increased, and an effect of preventing surface damage can be enhanced. A total addition amount of these elements is more preferably 1% by mass or more, and still more preferably 5% by mass or more. These elements can exhibit the above-described effects when the total addition amount is 0.1% by mass or more. In addition, when the total addition amount is 30% by mass or less, it is possible to prevent the alloy from becoming brittle.

Other metals such as iron, silicon, nickel, aluminum, vanadium, niobium, and manganese may be added to the alloy containing cobalt and chromium of the calendar roll surface portion 5′ (surface portion of the metal member in contact with the rubber material). For example, in the case of iron, iron can be added in an amount of 20% by mass or less. The lower limit value is not particularly limited, and is preferably 1% by mass or more. By adding iron to the alloy, the alloy forming the calendar roll surface portion 5′ (surface portion of the metal member in contact with the rubber material) can be produced relatively inexpensively. By adding iron in an amount of 1% by mass or more, such an effect in terms of cost can be exhibited. By adding iron in an amount of 20% by mass or less, it is possible to suppress a decrease in oxidation resistance and hardness. Alternatively, for example, in the case of silicon, aluminum, or vanadium, it can be added in an amount of 5% by mass or less. The lower limit value is not particularly limited, but it is preferably 0.1% by mass or more. By adding silicon, aluminum or vanadium to the alloy, toughness of the alloy forming the calendar roll surface portion 5′ (surface portion of the metal member in contact with the rubber material) may be improved. By adding these elements in an amount of 0.1% by mass or more, such an effect can be favorably exhibited. By adding these elements in an amount of 5% by mass or less, it is possible to prevent the alloy from becoming brittle. In addition, for example, in the case of nickel, nickel can be added in an amount of 25% by mass or less. The lower limit value is not particularly limited, but it is preferable to add nickel in an amount of 0.1% by mass or more. For example, in the case of niobium or manganese, niobium or manganese can be added in an amount of 5% by mass or less. The lower limit value is not particularly limited, but it is preferable to add niobium or manganese in an amount of 0.1% by mass or more. By adding nickel, niobium, or manganese to the alloy, the oxidation resistance of the alloy forming the calendar roll surface portion 5′ (surface portion of the metal member in contact with the rubber material) can be further improved. By adding these elements in an amount of 0.1% by mass or more, such an effect can be favorably exhibited. By adding nickel in an amount of 25% by mass or less or niobium or manganese in an amount of 5% by mass or less, an excessive increase in material cost can be suppressed.

In addition, surface roughness Ra of the calendar roll surface portion 5′ (surface portion of the metal member in contact with the rubber material) is preferably in a range of Ra = 0.1 µm or more and 1.0 µm or less. The surface roughness Ra is more preferably 0.2 µm or more, and still more preferably 0.3 µm or more. The surface roughness Ra is more preferably 0.8 µm or less, and still more preferably 0.5 µm or less. When the surface roughness Ra is 0.1 µm or more, a contact area between the metal member surface and the rubber material can be reduced, and the effect of preventing adhesion of the rubber material to the metal member can be further improved. When the surface roughness Ra is 1.0 µm or less, it is possible to prevent the rubber material from entering a gap of the surface. A numerical value of the surface roughness Ra can be adjusted by performing cutting, buffing, burnishing, roller finishing, electropolishing, lapping, liquid honing, shot blast treatment, edging, and the like. In the present specification, the surface roughness Ra can be measured by a contact type surface roughness meter.

In the metal member according to the present embodiment, not all of the surface (or surface portion) of the metal member in contact with the rubber material but at least a portion of the surface (or surface portion) of the metal member in contact with the rubber material may be formed from an alloy containing cobalt and chromium.

In addition, in the metal member according to the present embodiment, not only the surface portion of the metal member but also the entire metal member may be formed from an alloy containing cobalt and chromium. Also in this case, the alloy constituting the metal member can contain optionally-contained other elements as described above at the same mass ratio. Such a metal member can be produced by a method generally applied by those skilled in the art, such as casting, forging, and can making.

Next, as another example, FIG. 3 illustrates a schematic cross section of a calendar roll which is another example of the metal member according to the present embodiment. In FIG. 3, reference numeral 5 represents the calendar roll, reference numeral 7 represents the fluid passage, reference numeral 8 represents a metal base material, reference numeral 9 represents a covering layer, and reference numeral X represents a rotation axis. As illustrated in FIG. 3, the calendar roll 5 comprises the metal base material 8 and the covering layer 9 formed on a surface of the metal base material 8 in contact with the rubber material, and comprises the fluid passage 7 therein.

As described above, the fluid passage 7 is a passage for allowing a fluid such as water adjusted to a specific temperature to pass therethrough. A temperature of the covering layer 9 in contact with the rubber material (surface portion of the metal member in contact with the rubber material) is adjusted to a predetermined temperature range by using the fluid passage 7.

The metal base material 8 is formed from steel usually used as an underlying metal such as carbon steel, chromium molybdenum steel, or stainless steel, and is not particularly limited. Among these steels, carbon steel or chromium molybdenum steel is preferable as the metal base material 8 from the viewpoint of easily controlling the temperature due to a high heat transfer coefficient, being relatively inexpensive, being easy to process, and being capable of maintaining strength as various metal members.

The covering layer 9 is formed from an alloy containing cobalt and chromium. The mass ratio of these elements, the types of other elements that may optionally be included, and the mass ratio obtained when the elements are included are the same as in the case of the calendar roll surface portion 5′ (surface portion of the metal member in contact with the rubber material) of the above embodiment.

The covering layer 9 can be formed by, but not limited to, plating, spraying, welding (for example, build-up welding), physical vapor deposition (PVD) such as a sputtering method, or the like. For example, the covering layer 9 can be formed using a commercially available alloy such as “Stellite” (registered trademark), “Tribaloy” (registered trademark), and “Ultimet” (registered trademark) manufactured by Kennametal Inc., “COBARION” (registered trademark) manufactured by Eiwa Co., Ltd., or “Arcam ASTM F75 CoCr alloy”.

A thickness of the covering layer 9 may be set to a suitable thickness based on the type of the rubber material, the type and size of the metal member, the replacement period, and the like. For example, the thickness of the covering layer 9 can be 0.01 mm or more. The upper limit of the thickness of the covering layer 9 is not particularly limited.

A preferable numerical value of the surface roughness Ra of the covering layer 9 is also the same as in the case of the calendar roll surface portion 5′ (surface portion of the metal member in contact with the rubber material) of the above embodiment.

The covering layer 9 in the metal member according to the present embodiment may be formed not on the entire surface of the metal base material 8 in contact with the rubber material but on at least a portion of the surface of the metal base material 8 in contact with the rubber material.

### Method for Processing Rubber Material

A method for processing a rubber material according to the present embodiment is a method for processing a rubber material using the device comprising the metal member of the above embodiment, the method comprising: adjusting, to a predetermined temperature range, a temperature of the at least a portion of the surface of the metal member of the above embodiment in contact with the rubber material by allowing a fluid to pass through the fluid passage described above; and extruding the rubber material and/or rolling the rubber material.

According to the method according to the present embodiment, even when the surface temperature of the metal member is adjusted to a wide temperature range using the fluid passage for various types of rubber materials, adhesion of the rubber material to the metal member surface can be prevented when the rubber material is extruded and/or rolled. In addition, by adjusting the surface temperature of the metal member to a temperature at which the rubber material is most unlikely to adhere in accordance with the type of the metal member, the rubber material to be used, and the like, the effect of preventing adhesion of the rubber material can be maximally exhibited. The extrusion and/or rolling of the rubber material can be performed by rotationally driving the metal member such as a screw or a calendar roll with a motor or the like by a usual method.

As described above, according to the metal member in the present embodiment, when the constituent element of the surface portion of the metal member in contact with the rubber material is an alloy containing cobalt and chromium, it is possible to prevent adhesion to various types of rubber materials in a wide temperature range. For example, Patent Literature 2 discloses a technique of coating a mold release promoting layer in order to promote mold release of a rubber material. However, according to the metal member in the present embodiment, the constituent elements themselves on the metal member surface have the effect of preventing adhesion of the rubber material, and thus it is not necessary to further coat such a mold release promoting layer. In addition, since adhesion of the rubber material is suppressed, a frequency of cleaning of the metal member and the like are also reduced.

Although the outline of the present invention has been described above, the metal member and the method for processing the rubber material in the present embodiment are summarized as follows.

A metal member according to one aspect of the present invention is a metal member having a surface in contact with a rubber material, wherein
at least a portion of the surface of the metal member in contact with the rubber material is formed from an alloy containing cobalt and chromium, and
the metal member comprises a fluid passage for adjusting a temperature of the at least a portion of the surface of the metal member in contact with the rubber material.

In the metal member having such a configuration, the rubber material is less likely to adhere to various types of rubber materials in a wide temperature range.

In the metal member described above, the rubber material preferably comprises silica and a silane coupling agent.

When the rubber material comprises silica and a silane coupling agent, it is possible to more effectively exhibit the effect of preventing adhesion of the rubber material to the metal member in the present embodiment.

In the metal member described above, it is more preferable that the alloy further contains one or more elements selected from tungsten, molybdenum, boron, and carbon.

According to the metal member having such a configuration, the hardness of the alloy on the surface of the metal member in the present embodiment can be increased, and the effect of preventing surface damage of the metal member can be enhanced.

In the metal member described above, the surface roughness Ra of the at least a portion of the surface of the metal member in contact with the rubber material is more preferably Ra = 0.1 µm or more and 1.0 µm or less.

In the metal member having such a configuration, the effect of preventing adhesion of the rubber material to the metal member can be further improved by reducing the contact area between the metal member surface and the rubber material, and it is possible to prevent the rubber material from entering a gap of the metal member surface.

The metal member described above more preferably comprises a metal base material and a covering layer of the alloy containing cobalt and chromium on the at least a portion of the surface in contact with the rubber material. In other words, it is more preferable that the metal member further comprises the metal base material and the covering layer formed on the metal base material, and the covering layer is formed from the alloy containing cobalt and chromium and is formed on the at least a portion of the surface of the metal member in contact with the rubber material.

According to the metal member having such a configuration, a preferable metal base material, a preferable method of forming a covering layer, a preferable formation site of the covering layer, a preferable thickness, and the like can be selected according to the type of the metal member.

The metal member is more preferably any member selected from a screw that extrudes the rubber material, a barrel that is a housing of the screw and forms a flow path of the rubber material, a calendar roll of a roller head that rolls the rubber material, and a side guide provided at an end of the calendar roll.

When the metal member is selected from the above members, the rubber material is particularly likely to adhere to the above members, so that the effect of preventing adhesion of the rubber material to the metal member in the present embodiment can be more effectively exhibited.

A method for processing a rubber material according to another aspect of the above invention is a method for processing a rubber material using a device comprising the metal member according to one aspect described above, the method comprising:
adjusting, to a predetermined temperature range, a temperature of the at least a portion of the surface of the metal member in contact with the rubber material by allowing a fluid to pass through the fluid passage; and
extruding the rubber material and/or rolling the rubber material.

According to such a method for processing a rubber material, even when the surface temperature of the metal member is adjusted to a wide temperature range using the fluid passage for various types of rubber materials, adhesion of the rubber material to the metal member surface can be prevented when the rubber material is extruded and/or rolled.

In the method for processing a rubber material, it is preferable that an acid is used in the production of the rubber material or a raw material thereof.

Even when an acid is used in the production of the rubber material or a raw material thereof, according to the method for processing the rubber material in the present embodiment, since the metal member surface is hardly oxidized, it is possible to prevent the formation of a film of a silane coupling agent on the metal member surface, and it is possible to effectively prevent adhesion of the rubber material to the metal member surface.

In the method for processing a rubber material, the temperature range is more preferably 20° C. or higher and 90° C. or lower.

According to such a method for processing a rubber material, corrosion and the like of the metal member surface can be prevented, and generation of rubber scorch can be prevented in processing the rubber material.

In the method for processing a rubber material, the temperature range is still more preferably 30° C. or higher and 60° C. or lower.

According to such a method for processing a rubber material, corrosion and the like of the metal member surface can be prevented more reliably, and generation of rubber scorch can be prevented in processing the rubber material.

### EXAMPLES

Hereinafter, the present invention will be described more specifically with reference to Examples, but the present invention is not limited by Examples.

In Examples, a roller-head twin screw extruder (“TSR 125” manufactured by Kobe Steel, Ltd.) (screw tip diameter: 125 mm, roll diameter: 177 mm) was used, as an actual machine incorporating a calendar roll of Example 1 or any of Comparative Examples 1 to 3 thereinto. The calendar roll was rotationally driven at various cooling water temperatures (adjusting temperatures of a surface of the calendar roll), and extrusion and rolling were conducted using various types of rubber materials under conditions of a roll gap of 3 mm, a roll rotation speed of 3 rpm, and an extrusion load of 20 kN of rubber in an extrusion direction with respect to two rolls. Thereafter, an adhesion state of a rolled sheet to each calendar roll was visually checked to evaluate the effect of preventing adhesion of the rubber material.

Specifically, in Example 1, a calendar roll was used in which the metal base material was formed from carbon steel S25C and the covering layer was formed from cobalt and chromium. In Comparative Example 1, a calendar roll was used in which the metal base material was formed from carbon steel S25C and the covering layer was formed from chromium. In Comparative Example 2, a calendar roll was used in which the metal base material was formed from carbon steel S25C and the covering layer was formed from chromium and carbon. In Comparative Example 3, a calendar roll was used in which the metal base material was formed from carbon steel S25C and the covering layer was formed from cobalt, tungsten and carbon. The covering layer of each of Example 1 and Comparative Examples 1 to 3 was film-formed on the metal base material using a commercially available spray material composed of each constituent element while adjusting the surface roughness Ra and the thickness to be the same.

Raw materials of various rubber materials used for the evaluation and the mass ratios thereof are as follows. The mass ratio indicates a mass ratio when a total amount of the rubber component as the main component is 100 parts by mass, except for the case of the re-kneaded rubber material. The following raw materials were kneaded in a 14 L capacity meshing mixer (MIXTRON BB mixer “BB14IM” manufactured by Kobe Steel, Ltd.) to obtain a rubber material for evaluation. Kneading conditions of various rubber materials are also described below.

(Rubber material No. 1)
Styrene-butadiene rubber (SBR) 70 parts by mass
Butadiene rubber (BR) 30 parts by mass
Silica 80 parts by mass
Silane coupling agent 6.4 parts by mass
Phenol resin 10 parts by mass
Mineral process oil for rubber 15 parts by mass
Zinc oxide 3 parts by mass
Stearic acid 2 parts by mass
Antiaging agent 6 PPD (N-phenyl-N′-(1,3-dimethylbutyl)-p-phenylenediamine) 1.5 parts by mass
Paraffin wax 1 part by mass
Kneading conditions: A raw material was charged into a mixer, then kneaded at a rotor rotation speed of 50 rpm until the temperature reached 130° C., kneaded at a constant temperature of 130° C. for 2 minutes, further kneaded at 50 rpm until the temperature reached 150° C., and discharged. A total kneading time was about 4 minutes and 30 seconds.

(Rubber material No. 2)
Styrene-butadiene rubber (SBR) 90 parts by mass
Butadiene rubber (BR) 10 parts by mass
Silica 90 parts by mass
Silane coupling agent 9 parts by mass
Mineral process oil for rubber 39 parts by mass (including oil extender amount of SBR)
Stearic acid 1 part by mass
Kneading conditions: A raw material was charged into a mixer, then kneaded at a rotor rotation speed of 40 rpm until the temperature reached 155° C., and then discharged. The total kneading time was 3 minutes and 10 seconds.

(Rubber material No. 3)
Rubber material No. 2 (re-kneading) 239 parts by mass
Silica 10 parts by mass
Carbon black 9 parts by mass
Antiaging agent 6 PPD (N-phenyl-N′-(1,3-dimethylbutyl)-p-phenylenediamine) 2 parts by mass
Antiaging agent TMQ (2,2,4-trimethyl-1,2-dihydroquinoline polymer) 2 parts by mass
Zinc oxide 2 parts by mass
Paraffin wax 2 parts by mass
Vulcanization accelerator DPG (1,3-diphenylguanidine) 1.5 parts by mass
Kneading conditions: A raw material was charged into a mixer, then kneaded at a rotor rotation speed of 50 rpm until the temperature reached 140° C., further kneaded at 25 rpm until the temperature reached 155° C., and then discharged. The total kneading time was 3 minutes.

(Rubber material No. 4)
Styrene-butadiene rubber (SBR) 90 parts by mass
Butadiene rubber (BR) 10 parts by mass
Silica 100 parts by mass
Silane coupling agent 9 parts by mass
Mineral process oil for rubber 39 parts by mass (including oil extender amount of SBR)
Stearic acid 1 part by mass
Carbon black 9 parts by mass
Zinc oxide 2 parts by mass
Antiaging agent 6 PPD (N-phenyl-N′-(1,3-dimethylbutyl)-p-phenylenediamine) 2 parts by mass
Antiaging agent TMQ (2,2,4-trimethyl-1,2-dihydroquinoline polymer) 2 parts by mass
Paraffin wax 1 part by mass
Accelerator DPG (1,3-diphenylguanidine) 1.5 parts by mass
Kneading conditions: A raw material was charged into a mixer, then kneaded at a rotor rotation speed of 40 rpm until the temperature reached 135° C., further kneaded at 35 rpm until the temperature reached 155° C., and then discharged. The total kneading time was 3 minutes and 30 seconds.

(Rubber material No. 5)
Natural rubber (NR) 100 parts by mass
Carbon black 39 parts by mass
Mineral process oil for rubber 2 parts by mass
Antiaging agent 6 PPD (N-phenyl-N′-(1,3-dimethylbutyl)-p-phenylenediamine) 1 part by mass
Zinc stearate 1 part by mass
Kneading conditions: A raw material was charged into a mixer, then kneaded at a rotor rotation speed of 65 rpm until the temperature reached 153° C., and then discharged. The total kneading time was 1 minute and 45 seconds.

(Rubber material No. 6)
Rubber material No. 5 (re-kneading) 143 parts by mass
Carbon black 12 parts by mass
Phenol resin 9 parts by mass
Zinc oxide 5 parts by mass
Kneading conditions: A raw material was charged into a mixer, then kneaded at a rotor rotation speed of 40 rpm until the temperature reached 130° C., and then discharged. The total kneading time was 1 minute and 30 seconds.

(Rubber material No. 7)
Natural rubber (NR) 50 parts by mass
Styrene-butadiene rubber (SBR) 30 parts by mass
Butadiene rubber (BR) 20 parts by mass
Carbon black 64 parts by mass
Phenol resin 10 parts by mass
Mineral process oil for rubber 21 parts by mass (including oil extender amount of SBR)
Kneading conditions: A raw material was charged into a mixer, then kneaded at a rotor rotation speed of 50 rpm until the temperature reached 157° C., and then discharged. The total kneading time was 2 minutes and 20 seconds.

(Rubber material No. 8)
Rubber material No. 7 (re-kneading) 195 parts by mass
Accelerator CBG (N-cyclohexyl-2-benzothiazolylsulfenamide) 1 part by mass
Adhesive HMMM (hexamethoxymethylmelamine) 1.3 parts by mass
Sulfur 2.5 parts by mass
Kneading conditions: A raw material was charged into a mixer, then kneaded at a rotor rotation speed of 30 rpm until the temperature reached 100° C., and then discharged. The total kneading time was 1 minute and 30 seconds.

After each rubber material was extruded and rolled, a specific evaluation of the effect of preventing adhesion of the rubber material was performed for the calendar roll according to four evaluation categories: A: a rolled sheet did not adhere, B: the rolled sheet adhered but was peeled off by its own weight, C: the rolled sheet adhered but was peeled off by hand, and D: the rolled sheet adhered and operation could not be performed. The evaluation results are summarized in Table 1 below. The evaluation in a case where the test has been performed a plurality of times indicates the evaluation category of the average. “B+” indicates an evaluation category between A and B, and “C+” indicates an evaluation category between B and C. When the evaluation category D was obtained even once after a plurality of times of the test, that is, when the extruder became inoperable, the evaluation category was “D”. “-” indicates unmeasured.

TABLE 1

| | Example 1 | | | | Comparative Example 1 | | | | Comparative Example 2 | | | | Comparative Example 3 | | | |
|---|---|---|---|---|---|---|---|---|---|---|---|---|---|---|---|---|
| Covering layer constituent element | Cobalt/chromium | | | | Chromium | | | | Chromium/carbon | | | | Cobalt/tungsten/carbon | | | |
| Cooling water temperature | Normal temperature | 40° C. | 60° C. | 80° C. | Normal temperature | 40° C. | 60° C. | 80° C. | Normal temperature | 40° C. | 60° C. | 80° C. | Normal temperature | 40° C. | 60° C. | 80° C. |
| Rubber material No. 1 | B | B | B | B | B | C | C | C | C | - | - | - | C | D | D | - |
| Rubber material No. 2 | A | B | A | A | B | C | A | A | A | - | - | - | - | - | - | - |
| Rubber material No. 3 | A | C | A | A | C+ | C | C | A | C | - | - | - | - | - | - | - |
| Rubber material No. 4 | C | C+ | A | A | C | D | A | A | C | C | A | A | - | - | - | - |
| Rubber material No. 5 | A | A | A | A | A | A | A | A | A | - | - | - | - | - | - | - |
| Rubber material No. 6 | B+ | A | A | A | C | C | C | C | C | - | - | - | - | - | - | - |
| Rubber material No. 7 | C+ | C+ | B+ | B | C+ | D | D | C | C | C | B | B | - | - | - | - |
| Rubber material No. 8 | C | C | C+ | C | C+ | D | D | D | D | C | B | C | - | - | - | - |

As shown in Table 1 above, only Example 1 which was an example of the present invention was not determined as the evaluation category “D” at all cooling water temperatures in all types of rubber materials. That is, it has been found that when the surface of the calendar roll in contact with the rubber material is an alloy containing cobalt and chromium, it is possible to prevent the rubber material from adhering to the calendar roll over a wide temperature range for various types of rubber materials.

Conventionally, there are many calendar rolls of Comparative Example 1 in which the covering layer is formed from chromium (or the calendar roll of Comparative Example 2 in which the covering layer is formed from chromium and carbon). As compared with the evaluation result of Comparative Example 1, in Example 1, not only the rubber materials No. 1 to No. 4 comprising silica and a silane coupling agent as the raw materials but also the rubber materials No. 5 to No. 8 composed of other raw materials were determined as good evaluation categories over a wide temperature range. Comparative Example 3 was an example in which the covering layer in which tungsten was combined with constituent elements was formed in order to make the roll harder in consideration of scratch resistance and abrasion resistance due to silica. However, as can be seen from the results of the rubber material No. 1, adhesion of the rubber material was hardly prevented.

This application is based on Japanese Patent Application Serial No. 2020-125671 filed in Japan Patent Office on Jul. 22, 2020 and Japanese Patent Application Serial No. 2020-204866 filed in Japan Patent Office on Dec. 10, 2020, the contents of which are hereby incorporated by reference.

To describe the present invention, the present invention has been described in the foregoing description appropriately and sufficiently using the embodiment and Examples with reference to specific examples and the like. However, it is to be understood that changes and/or modifications to the foregoing embodiment and Examples will readily occur to those skilled in the art. Therefore, unless a change or modification made by those skilled in the art is beyond the scope of the appended claims, such change or modification is to be embraced within the scope of the appended claims.

### INDUSTRIAL APPLICABILITY

According to the present invention, in a technical field related to metal members such as a screw, a barrel, a calendar roll, and a side guide provided in a rubber material processing device, it is possible to exhibit a rubber material adhesion preventing effect in a wide temperature range regardless of the type of rubber material to be processed.

1. A metal member having a surface in contact with a rubber material, wherein
at least a portion of the surface of the metal member in contact with the rubber material is formed from an alloy containing cobalt and chromium, and
the metal member comprises a fluid passage for adjusting a temperature of the at least a portion of the surface of the metal member in contact with the rubber material.

2. The metal member according to claim 1, wherein the rubber material comprises silica and a silane coupling agent.

3. The metal member according to claim 1, wherein the alloy further contains one or more elements selected from tungsten, molybdenum, boron, and carbon.

4. The metal member according to claim 1, wherein a surface roughness Ra of the at least a portion of the surface of the metal member in contact with the rubber material is 0.1 µm or more and 1.0 µm or less.

5. The metal member according to claim 1, wherein the metal member further comprises a metal base material and a covering layer formed on the metal base material, and the covering layer is formed from the alloy containing cobalt and chromium and is formed on the at least a portion of the surface of the metal member in contact with the rubber material.

6. The metal member according to claim 1, wherein the metal member is any member selected from a screw that extrudes the rubber material, a barrel that is a housing of the screw and forms a flow path of the rubber material, a calendar roll of a roller head that rolls the rubber material, and a side guide provided at an end of the calendar roll.

7. A method for processing a rubber material using a device comprising the metal member according to claim 1, the method comprising:
adjusting, to a predetermined temperature range, a temperature of the at least a portion of the surface of the metal member in contact with the rubber material by allowing a fluid to pass through the fluid passage; and
extruding the rubber material and/or rolling the rubber material.

8. The method for processing a rubber material according to claim 7, wherein an acid is used in production of the rubber material or a raw material of the rubber material.

9. The method for processing a rubber material according to claim 7, wherein the temperature range is 20° C. or higher and 90° C. or lower.

10. The method for processing a rubber material according to claim 9, wherein the temperature range is 30° C. or higher and 60° C. or lower.
